(19) United States
(12) Patent Application Publication
(10) Pub. No.: US 2002/0088088 A1
(43) Pub. Date: Jul. 11, 2002

(54) Hand tool with a detachable working piece

(76) Inventor: Chi-Fu Lin, Yungkang City (TW)

Correspondence Address: Hedman, Gibson & Costigan, P.C., 1185 Avenue of the Americas, New York, NY, 10036-2646, US

(21) Appl. No.: 09/756,078

(22) Filed: Jan. 8, 2001

(51) Int. Cl. E05B 1/00

(52) U.S. Cl. 16/422

(57) ABSTRACT

A hand tool with a detachable working piece includes a handle having a stud extending out from one end of the handle and a working piece detachably attached to the end of the handle. A locking pin extends through the working piece and the stub of the handle to prevent the working piece from inadvertently detaching from the handle. The locking pin has two steel balls movably mounted in the locking pin and partially extending out from the locking pin to prevent the locking pin from inadvertently detaching from the handle and the working piece. The user can change the working pieces rapidly and easily to deal with changing requirements. Furthermore, the hand tool will save money and storage space because only one handle is needed.

### BACKGROUND OF THE INVENTION

1. Field of the Invention

The present invention relates to a hand tool, and more particularly to a hand tool with a detachable working piece so that the working piece of the hand tool can be changed to meet various needs of the user.

2. Description of Related Art

A conventional hand tool in accordance with the prior art comprises a handle and a working piece securely attached to one end of the handle so that each hand tool has only one corresponding function. The user must possess multiple hand tools to deal with multiple needs. A complete set of individual tools with handles to meet all of user's needs is very expensive. Furthermore, many complete individual hand tools occupy a large space when stored.

The present invention has arisen to mitigate and/or obviate the disadvantages of the conventional hand tool.

### SUMMARY OF THE INVENTION

The main objective of the present invention is to provide a hand tool with a detachable working piece that can save money and storage space, and the working piece is easily and quickly detached, replaced and assembled. The hand tool with a detachable working piece in accordance with the present invention comprises a handle having a stud extending out from one end of the handle and a working piece detachably mounted on the end of the handle. A locking pin extends through the working piece and the stub of the handle to prevent the working piece from inadvertently detaching from the handle. Two steel balls are movably mounted in the locking pin and partially extend out from the locking pin to prevent the locking pin from inadvertently detaching from the handle and the working piece.

Further benefits and advantages of the present invention will become apparent after a careful reading of the detailed description with appropriate reference to the accompanying drawings.

### BRIEF DESCRIPTION OF THE DRAWINGS

FIG. 1 is a top plan view of a hand tool with a detachable working piece in accordance with the present invention;

FIG. 2 is an exploded perspective view of the hand tool in FIG. 1 with multiple working pieces that can be attached; and

FIG. 3 is a top plan view in partial section of a locking pin of the hand tool with a detachable working piece along line 3-3 in FIG. 2.

### DETAILED DESCRIPTION OF THE INVENTION

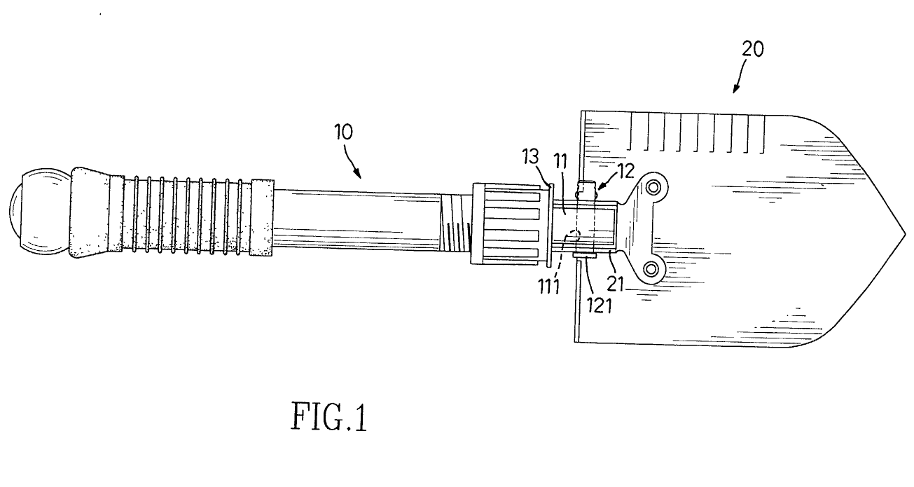

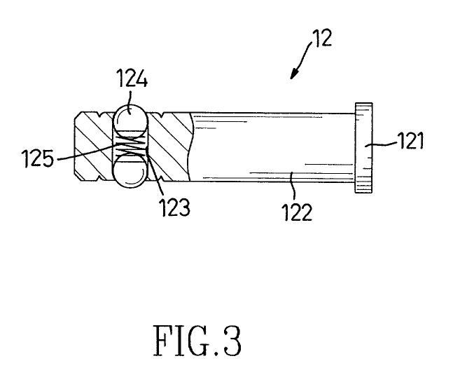

With reference to the drawings and initially to FIGS. 1 to 3, a hand tool with a detachable working piece in accordance with the present invention comprises a handle (10), a working piece (20) and a locking pin (12). The working piece (20) is attached to one end of the handle (10). The locking pin (12) extends through the working piece (20) and the handle (10) to hold the working piece (20) in place.

The handle (10) includes a stub (11) axially extending out from one end of the handle (10). The cross section of the handle (10) is larger than that of the stub (11). The stud (11) includes two opposite sides parallel to each other. A through hole (111) is defined in the stub (11) and connects the two opposite sides of the stub (11). A washer (13) is mounted between the handle (10) and the working piece (20). The washer (13) includes a hole (131) centrally defined in the washer (13). The shape of the hole (131) in the washer (13) corresponds to and is lightly larger than the section of the stub (11).

Two plates (21) are attached to the end of the working piece (20). The two plates (21) are parallel to each other and form a passage (210) between the two plates (21) of the working piece (20). The passage (210) is slightly wider than two parallel sides of the stub (11). Each of the plates (21) has a hole (211) defined to correspond to the through hole (111) in the stub (11). The diameter of the hole (211) is the same as the through hole (111) in the stub (11).

The locking pin (12) includes a head (121) and a shank (122) extending from the head (121). The head (121) has a diameter larger than that of the hole (211) in the plate (21) and the through hole (111) in the stub (11). The shank (122) has a diameter lightly smaller than that of the through hole (111) in the stub (11). The shank (122) has a locking hole (123) defined near the end of the shank (122) opposite from the end with the head (121). Two steel balls (124) are movably mounted in the two opposite ends of the locking hole (123) with one ball (124) at each end of the hole and partially extending out from the shank (122). A spring (125) is compressively mounted in the locking hole (123) in the shank (122) between the steel balls (124).

To assemble the handle (10) and the working piece (20), the stub (11) on handle (10) extends through the hole (131) in the washer (132) and is inserted into the passage (210) in the working piece (20). The washer (13) has two sides respectively abutting the end of the handle (10) and exterior sides of the two plates (211) to prevent the handle (10) and the working piece (20) from pivoting. The through hole (111) in the stub (11) aligns with the two holes (211) in the two plates (21) after the stub (11) is fully being inserted into the passage (210). The shank (122) of the locking pin (12) extends through the two plates (21) on the working piece (20) and the stub (111) on the handle (10) to prevent the working piece (20) from inadvertently detaching from the handle (10). The steel balls (124) mounted in the locking hole (123) are pressed and compress the spring (125) when passing through the plates (21) and the stub (11), and partially extending out from the shank (122) after extending through the plates (21) and the stub (11) to prevent the locking pin (12) from inadvertently detaching from the handle (10) and the working piece (20). The shape of the hole (211) in the plate (21), the through hole (111) in the stub (11) and the section of the shank (122) of the locking pin (12) may be round or polygonal.

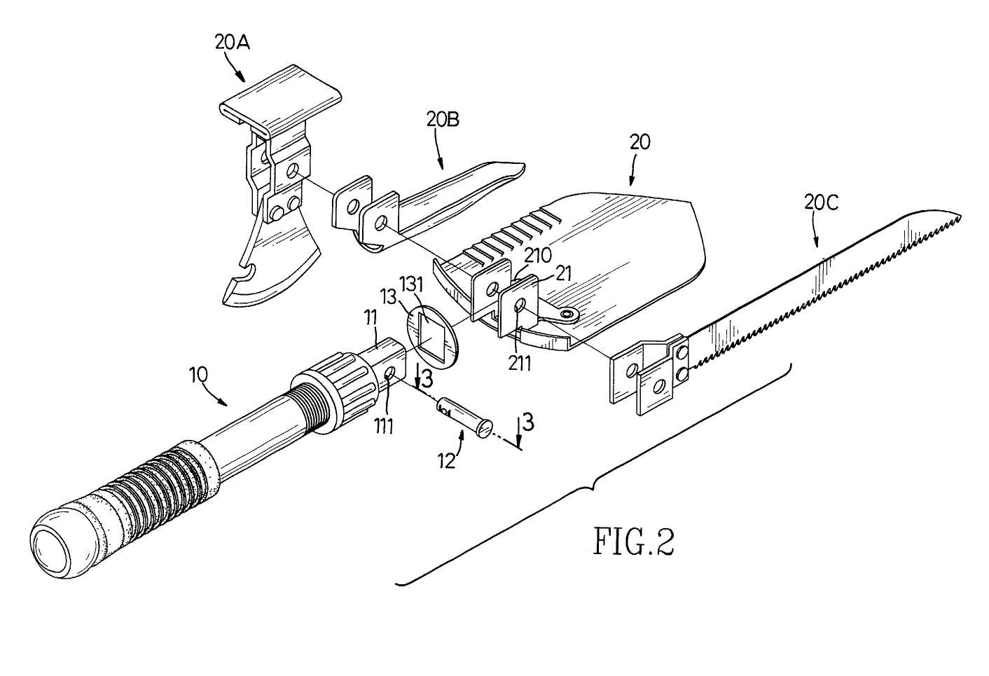

With reference to FIG. 2, the working piece (20) is detachable and can be replaced by a hatchet (20A), a shovel (20B), a saw (20C) and so on. The user can change the working pieces rapidly and easily to deal with changing requirements. Furthermore, the hand tool in accordance with the present invention will save money because only one handle is needed.

Although the invention has been explained in relation to its preferred embodiment, it is to be understood that many other possible modifications and variations can be made without departing from the spirit and scope of the invention as hereinafter claimed.

What is claimed is:

1. A hand tool with a detachable working piece comprising:
a handle having a stub extending outward from one end of the handle, the handle having a section larger than that of the stub, the stub including two opposite sides parallel to each other and a through hole extending through the two parallel sides;
a working piece attached to the end of the handle, the working piece including two plates secured on one end of the working piece, the two plates being parallel to each other and forming a passage between the two plates, the passage having a width slightly larger than a distance between the two parallel sides of the stub, the two plates respectively having a hole defined to correspond to each other and the through hole in the stub; and
a locking pin having a shank detachably inserted into the holes of the two plates and the through hole of the stub to attach the working piece to the handle.

2. The hand tool with a detachable working piece as claimed in claim 1, wherein the stub axially extends from the end of the handle.

3. The hand tool with a detachable working piece as claimed in claim 1, wherein the stub is rectangular.

4. The hand tool with a detachable working piece as claimed in claim 1, wherein the holes in the plates of the working piece have a shape the same as and equal in diameter to the through hole in the stub of the handle, and the shank has a section corresponding to the shape of the hole in the plate.

5. The hand tool with a detachable working piece as claimed in claim 1, wherein the locking pin comprises a head on one end of the shank, the head having a diameter larger than that of the hole in the plate.

6. The hand tool with a detachable working piece as claimed in claim 4, wherein the hole in the plate, the through hole in the stub and the section of the shank are polygonal.

7. The hand tool with a detachable working piece as claimed in claim 4, wherein the hole in the plate, the through hole in the stub and the section of the shank are round.

8. The hand tool with a detachable working piece as claimed in claim 5, wherein the locking pin comprises a locking hole defined near one end of the shank opposite to the head, two steel balls are movable mounted in the locking hole with one ball at each end of the hole and partially extending out from a periphery of the shank, a spring compressively mounted in the locking hole between the steel balls.
